(19) United States
(12) Patent Application Publication
(10) Pub. No.: US 2017/0111207 A1
(43) Pub. Date: Apr. 20, 2017

(54) NFV SYSTEM AND METHOD FOR LINKING VNFM

(71) Applicant: Electronics and Telecommunications Research Institute, Daejeon (KR)

(72) Inventor: Seung-Hyun YOON, Daejeon (KR)

(21) Appl. No.: 15/292,969

(22) Filed: Oct. 13, 2016

(30) Foreign Application Priority Data
Oct. 14, 2015 (KR) 10-2015-0143714

(51) Int. Cl. H04L 12/24; H04L 29/08

(52) U.S. Cl. CPC H04L 41/044; H04L 67/10

(57) ABSTRACT

An NFV system in accordance with an embodiment of the present invention includes: a plurality of VNFs; NFVO configured for making a request for control or creation of the VNF; dispersed NFVIs including the VNF; a plurality of VIMs configured for managing the NFVI for each of the NFVIs; at least one VNFM being linked with the VIM and the NFVO and configured for managing the VNF.

### CROSS-REFERENCE TO RELATED APPLICATIONS

This application claims the benefit of Korean Patent Application No. 10-2015-0143714, filed with the Korean Intellectual Property Office on Oct. 14, 2015, the disclosure of which is incorporated herein by reference in its entirety.

### BACKGROUND

1. Technical Field

The present invention relates to a network function virtualization system and a method for linking a virtual network function manager, more specifically to a system and a method for effectively operating a virtual network function manager when there are multiple virtual infrastructure managers because network function virtualization infrastructure is dispersed in a network function virtualization environment.

2. Background Art

There has been an increased interest in network function virtualization (NFV), in which physical network equipment is virtualized on a general server. Unlike the convention way of using physical equipment, NFV uses cloud resources to operate network functions, and thus the function of managing and controlling NFV is important.

Accordingly, the NFV standard of ETSI (European Telecommunications Standards Institute) defines the reference structure including management and orchestration functions as shown in FIG. 1.

Referring to FIG. 1, management and orchestration (MANO) includes NFV orchestrator (NFVO), a plurality of virtual network function managers (VNFMs) and virtual infrastructure manager (VIM) operating NFV infrastructure (NFVI)

VIM functions similarly to a cloud OS (cloud management platform) that manages and controls a cloud center. Accordingly, if an NFV-based communication network is established, it is expected that a plurality of NFVIs that are geographically dispersed will be established and VIMs for proximal management of the NFVIs will be also dispersed.

Therefore, unlike operating a single VIM and NFVI, the structure as shown in FIG. 2 is formed between the actual NFVO and VNFM and the dispersed VIMs.

Referring to FIG. 2, the VNFM performs a function of maintaining and managing VNFs. Accordingly, a reliable and dependable connection is required between the VNFM and the VNFs. However, the VNFM may be overloaded when the NFV system is established in the structure shown in FIG. 2, causing a problem with a smooth operation of VNFs. Moreover, when the number of VIMs is increased, there may be a problem with the expandability of VNFMs.

### SUMMARY

An embodiment of the present invention provides an NFV system including a plurality of VNFMs and a method of linking VNFMs, in an NFV system including geographically dispersed VIMs and NFVIs.

An NFV system in accordance with an embodiment of the present invention includes: a plurality of VNFs; NFVO configured for making a request for control or creation of the VNF; dispersed NFVIs including the VNF; a plurality of VIMs configured for managing the NFVI for each of the NFVIs; VNFM being linked with the VIM and the NFVO and configured for managing the VNF.

The VNFM may include: main VNFM being linked with the NFVO; and agent VNFM being linked with the main VNFM and configured for managing the VNF.

The VNFM may include: a plurality of main VNFMs being linked with the NFVO and placed according to each vendor; and combined agent VNFM being commonly instructed by the plurality of main VNFMs and configured for managing the VNF.

The NFVO may search for VNFM managing the VNF when the VNF is controlled or a new VNF is created.

The NFVO may search for a location of the NFVI and then search for VNFM managing the VNF based on the location of the NFVI, when the VNF is controlled or the new VNF is created.

The main VNFM may manage mapping information of the agent VNFM in order to control or create the VNF pursuant to the request made by the NFVO, and the agent VNFM may be provided in plurality.

The combined agent VNFM may include a VNFM search database.

A method of linking VNFM in accordance with another embodiment of the present invention includes: making a request for control or creation of VNF, the request being made by NFVO; searching for VNFM managing the VNF; and linking the NFVO with the VNFM.

The method may further include, after the step of making the request for creation of the VNF, writing information about VNFM managing the VNF based on a location of NFVI in which the VNF is to be installed.

The VNFM may include: main VNFM being linked with the NFVO; and agent VNFM being linked with the main VNFM and configured for managing the VNF.

The VNFM may include: a plurality of main VNFMs being linked with the NFVO and placed according to each vendor; and combined agent VNFM being commonly instructed by the plurality of main VNFMs and configured for managing the VNF.

The main VNFM may manage mapping information of the agent VNFM in order to control or create the VNF pursuant to the request made by the NFVO, and the agent VNFM may be provided in plurality.

The combined agent VNFM may include a VNFM search database.

According to an embodiment of the present invention, it is possible to establish an efficient NFV environment since multiple VIMs and NFVIs may be supported. Specifically, a reliable and dependable connection is possible between VNFM and VNF within the NFV system according to an embodiment of the present invention, and it is possible to expand the VNFM even if VIMs are increased.

### BRIEF DESCRIPTION OF DRAWINGS

FIG. 1 illustrates an NFV reference structure provided by the ETSI standard.

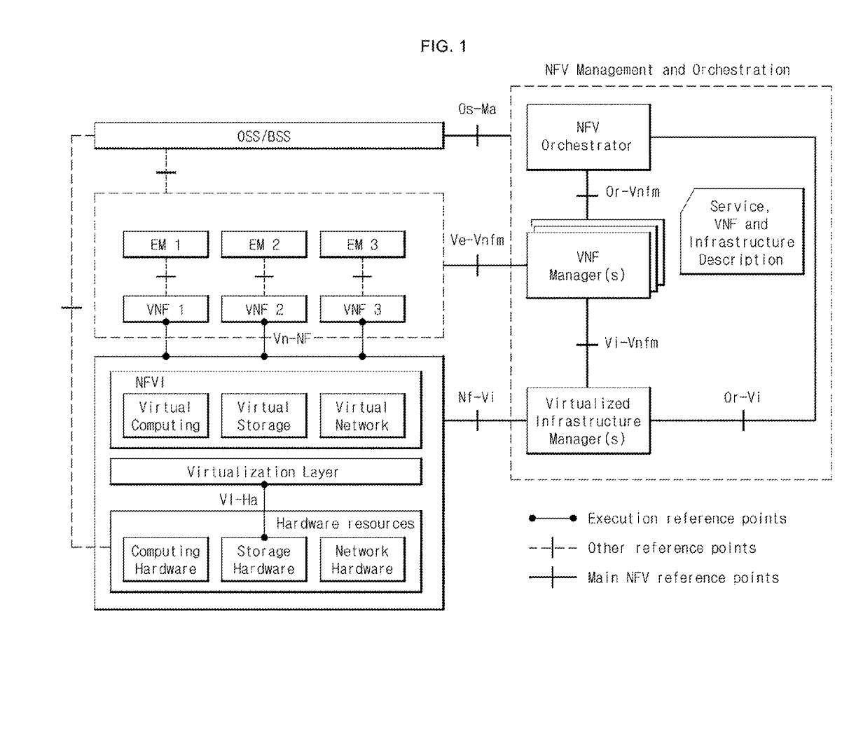

FIG. 2 illustrates an NFV system in which dispersed VIMs are organized.

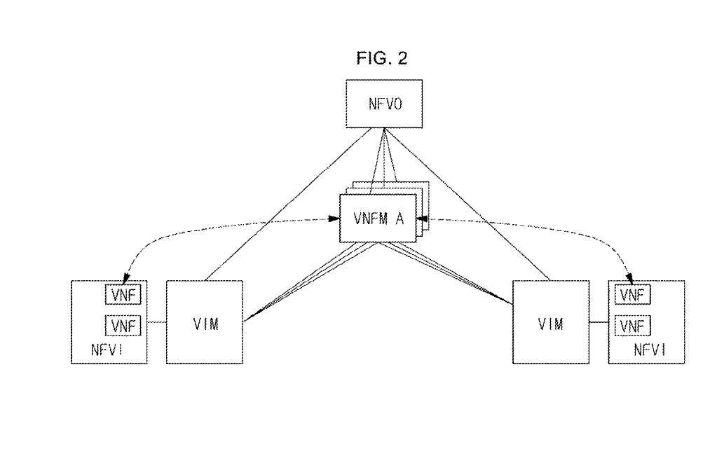

FIG. 3 illustrates an NFV system in accordance with an embodiment of the present invention.

FIG. 4 illustrates an NFV system in accordance with another embodiment of the present invention.

FIG. 5 illustrates a main VNFM and an agent VNFM in the NFV system shown in FIG. 4.

FIG. 6 illustrates an NFV system in accordance with another embodiment of the present invention.

FIG. 7 illustrates a method of linking VNFMs in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Unless clearly used otherwise, expressions in a singular form shall be generally interpreted to mean “one or more.”

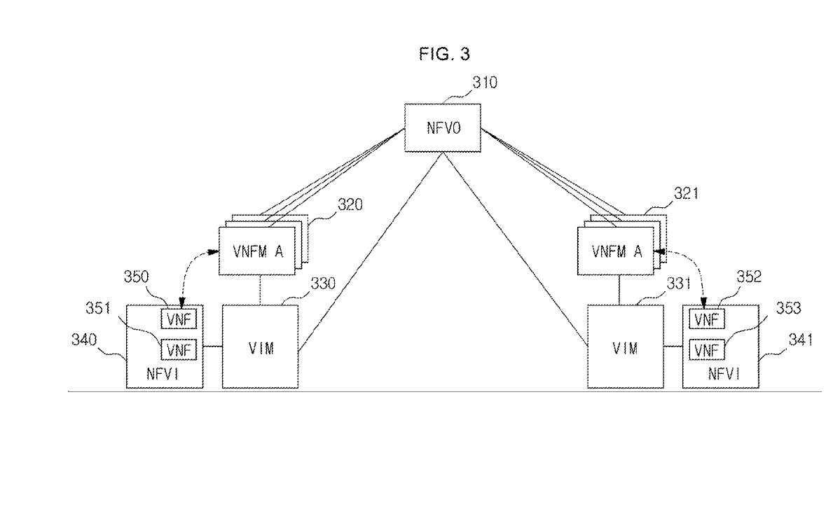

FIG. 3 illustrates an NFV system in accordance with an embodiment of the present invention.

Referring to FIG. 3, an NFV system 300 includes NFVO 310, VNFM 320, 321, VIM 330, NFVI 340 and VNF 350.

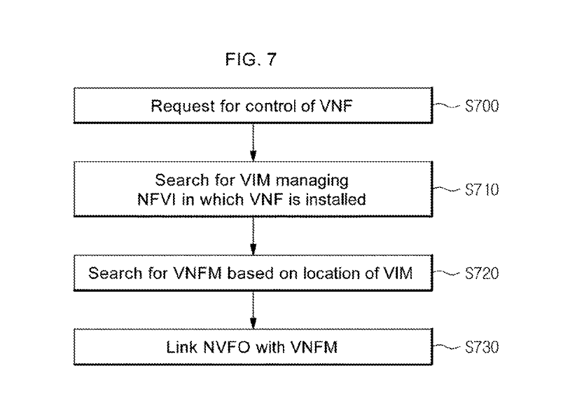

NFVO 310 may use a plurality of VNFMs 320, 321 to manage resources located in NFVI 340. For instance, NFVO 310 may request for control or generation of VNF 350. Here, NFVO 310 may link with VNFM 320, 321. It will be described with reference to FIG. 7 how NFVO 310 and VNFM 320, 321 link.

VNFM 320, 321 may manage a plurality of VNFs 350-353 while linking with NFVO 310.

VIMs 330, 331 may manage NFVIs 340, 341, respectively. Moreover, if NFVIs 340, 341 are geographically dispersed and configured in plurality, VIMs 330, 331 may be also dispersed and configured in plurality.

NFVI 340 may include a plurality of VNFs 350, 351.

In the NFV system shown in FIG. 3, since VNFMs 320, 321 are placed for VIMs 330, 331, respectively, VNFMs 320, 321 may not only link with NFVO 310 and VIMs 330, 331 but also manage VNFs 350-353 located inside NFVIs 340, 341 managed by VIMs 330, 331 according to a standard interface method. In such a case, however, it is inevitable that the same VNFM is installed for every VIM 330, 331 and that a plurality of VNFMs are integrally managed by NFVO 310.

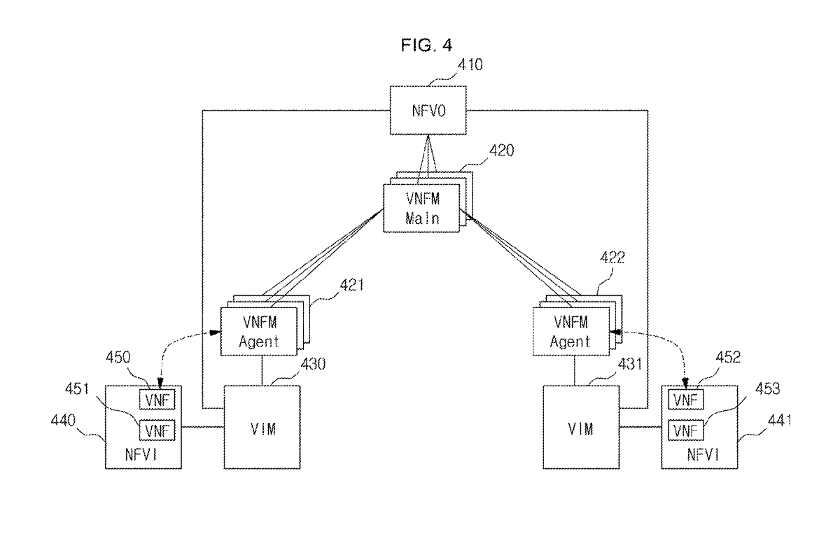

FIG. 4 illustrates an NFV system in accordance with another embodiment of the present invention.

Referring to FIG. 4, an NFV system 400 includes NFVO 410, main VNFM 420, agent VNFMs 421, 422, VIMs 430, 431, NFVIs 440, 441 and VNFs 450-453. Hereinafter, description of any elements of the NFV system 400 that are identical with the elements of the NFV system 300 shown in FIG. 3 will be omitted, and elements of the NFV system 400 that are different from the elements of the NFV system 300 shown in FIG. 3 will be mainly described.

VNFM may be divided into main VNFM 420 and agent VNFMs 421, 422. Here, NFVO 410 of the NFV system 400 shown in FIG. 4 may link with main VNFM 420 regardless of the location.

Main VNFM 420 is linked with NFVO 410 and may manage a plurality of agent VNFMs 421, 422. For example, main VNFM 420 may link with agent VNFM based on agent VNFM mapping information, for generation of VNF requested by NFVO 410. Specifically, when NFVO 410 requests for generation of a new VNF, NFVO 410 may inform main VNFM 420 about NFVIs 440, 441 in which the new VNF is to be installed. Here, VNFM 420 may link with agent VNFMs 421, 422 corresponding to locations of NFVIs 440, 441 in which the VNF is to be installed. Therefore, main VNFM 420 may manage the agent VNFM mapping information.

Agent VNFMs 421, 422 are linked with main VNFM 420 and may manage a plurality of VNFs 450-453. Accordingly, agent VNFMs 421, 422 may not only link with VIMs 430, 431, respectively, but also manage VNFs 450-453 located inside NFVIs 440, 441 managed by VIMs 430, 431 according to a standard interface method.

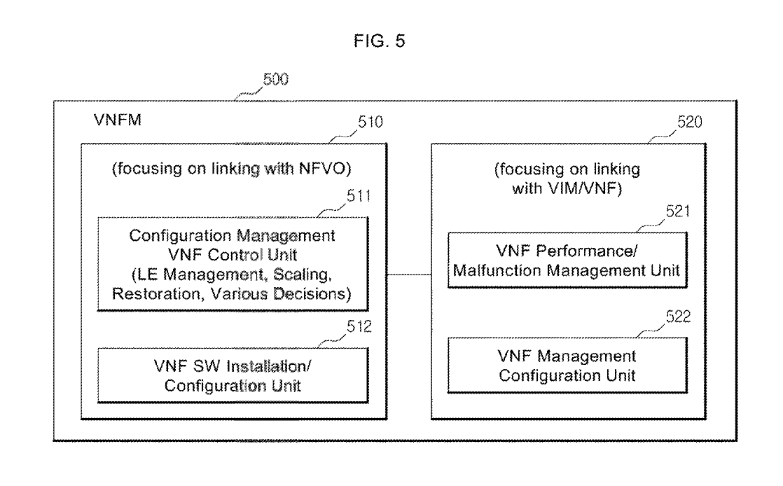

FIG. 5 illustrates main VNFM and agent VNFM in the NFV system shown in FIG. 4.

Referring to FIG. 5, VNFM 500 includes main VNFM 510 and agent VNFM 520. Hereinafter, description of any elements of the NFV system that are identical with the elements of the NFV system 400 shown in FIG. 4 will be omitted, and elements of the NFV system that are different from the elements of the NFV system 400 shown in FIG. 4 will be mainly described.

VNFM 500 may be divided into main VNFM 510, focusing on linking with NFVO, and agent VNFM 520, focusing on linking with VIM/VNF.

Main VNFM 510 includes a configuration management VNF control unit 511 and a VNF software installation/configuration unit 512.

The configuration management VNF control unit 511 is configured for lifecycle management, auto-scaling of VNF and automatic restoration for VNF regularly or irregularly according to the requirement or policy of NFVO. The configuration management VNF control unit 511 may be realized in different software blocks or in a single software block, depending on how the system is designed.

The VNF software installation/configuration unit 512 may install or configure VNF software. Specifically, the VNF software installation/configuration unit 512 is linked with the configuration management VNF control unit 511 and may install, upgrade and patch software for creating VNF and configure basic operations for VNF. Moreover, the VNF software installation/configuration unit 512 may be realized integrally with the configuration management VNF control unit 511, depending on how the system is designed.

Agent VNFM 520 includes a VNF performance/malfunction management unit 521 and a VNF management configuration unit 522.

The VNF performance/malfunction management unit 521 may manage the performance and malfunction of VNF, and, for this, may collect information about the performance and malfunction regularly or irregularly from VIM or VNF. For this, it is required that VNFM regularly collects a large amount of information about the performance and malfunction without loss or delay from VIM or VNF and thus is frequently linked with VNF and VIM.

The VNF management configuration unit 522 performs the configuration related to management of VNF.

Separating the functions of main VNFM and agent VNFM based on frequency, loss and delay conditions, as described above, is merely one embodiment, and various ways of distributing the functions of main VNFM and agent VNFM are actually possible.

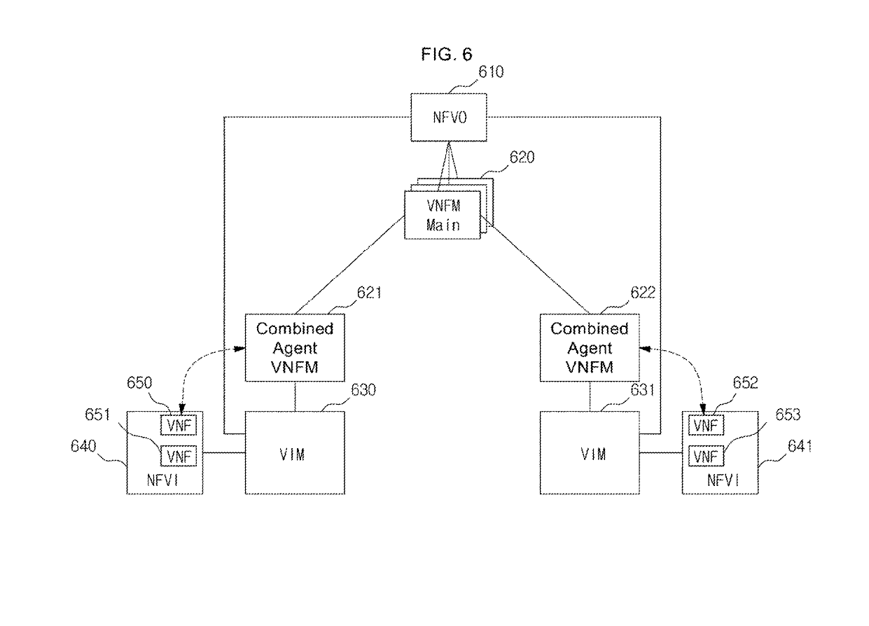

FIG. 6 illustrates an NFV system in accordance with another embodiment of the present invention.

Referring to FIG. 6, NFV system 600 includes NFVO 610, main VNFM 620, combined agent VNFM 621, 622, VIM 630, 631, NFVI 640, 641 and VNF 650-653. Hereinafter, description of any elements of the NFV system 600 that are identical with the elements of the NFV system 300 and the NFV system 400 shown in FIG. 3 and FIG. 4, respectively, will be omitted, and elements of the NFV system 600 that are different from the elements of the NFV system 300 and the NFV system 400 shown in FIG. 3 and FIG. 4, respectively, will be mainly described.

According to the ETSI NFV standard, VNFM is supplied by a VNF vendor. Accordingly, in the case where VNFM is divided into main VNFM and agent VNFM, it is required that main VNFM and agent VNFM are each installed by each corresponding vendor, causing an increased cost for installing and operating main VNFM and agent VNFM according to each vendor. Therefore, the NFV system 600 shown in FIG. 6 includes main VNFM 620 placed according to the vendor and combined agent VNFM 621, 622 commonly used by main VNFM 620.

Main VNFM 620 may be linked with NFVO 610 and combined agent VNFM 621, 622.

Combined agent VNFM 621, 622 may manage VNF 650-653 according to commands made by a plurality of VNFMs 620 placed according to the vendor. Combined agent VNFM 621, 622 may be pre-installed by a common carrier. Moreover, combined agent VNFM 621, 622 may include a VNFM search database in order to be linked with main VNFM 620. The VNFM search database may include VNFM information controlling the pertinent VNF, for example, VNFM mapping information for VNF. Moreover, when VNF is installed, combined agent VNFM 621, 622 may update the VNFM mapping information for the pertinent VNF to maintain and manage the VNFM search database.

With the NFV system 600 illustrated in FIG. 6, it is possible to configure the system capacity according to the capacity of each NFVI 640, 641 when combined VNFM 621, 622 is installed. Moreover, it is possible to reduce the cost of installing agent VNFM in every location in which NFVIs 640, 641 are dispersed.

FIG. 7 illustrates a method of linking VNFMs in accordance with an embodiment of the present invention.

Referring to FIG. 7, in step S700, NFVO makes a request for control of VNF. Moreover, NFVO may make a request for creation of VNF. For control or creation of VNF, it is required that NFVO is linked with VNFM. Here, since VNFM provided by a same vendor is installed at every location of VIM, it is required that NFVO searches for information of VNFM for each vendor as well as information on the installation location.

In step S710, in order to control VNF, NFVO searches for VIM that manages NFVI in which VNF is installed. Moreover, NFVO may search for VIM that manages NFVI in which VNF is to be installed.

In step S720, NFVO searches for VNFM managing VNF based on the location of VIM. Specifically, once a corresponding area is found by searching for VIM, NFVO searches for VNFM managing VNF based on the corresponding area. Step S710 and step S720 may be reversed. For example, pursuant to a request for control or creation of VNF, NFVO may search for VNFM managing the pertinent VNF. Afterwards, NFVO may be linked with VNFM by searching for VIM.

In step S730, NFVO is linked with the searched VNFM.

Information on VIM in which VNF is installed or information on VNFM managing VNF may be managed through an independent database table (e.g., NS (network service) database of VNF management database). The pertinent information may be updated and managed whenever new VNF is created.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. An NFV system comprising:
a plurality of VNFs;
NFVO configured for making a request for control or creation of the VNF;
dispersed NFVIs including the VNF;
a plurality of VIMs configured for managing the NFVI for each of the NFVIs;
at least one VNFM being linked with the VIM and the NFVO and configured for managing the VNF.

2. The NFV system of claim 1, wherein the VNFM comprises:
main VNFM being linked with the NFVO; and
agent VNFM being linked with the main VNFM and configured for managing the VNF.

3. The NFV system of claim 1, wherein the VNFM comprises:
a plurality of main VNFMs being linked with the NFVO and placed according to each vendor; and
combined agent VNFM being commonly instructed by the plurality of main VNFMs and configured for managing the VNF.

4. The NFV system according to any one of claim 1, wherein the NFVO is configured to search for VNFM managing the VNF when the VNF is controlled or a new VNF is created.

5. The NFV system of claim 4, wherein the NFVO is configured to search for a location of the NFVI and then search for VNFM managing the VNF based on the location of the NFVI, when the VNF is controlled or the new VNF is created.

6. The NFV system of claim 3, wherein the main VNFM is configured to manage mapping information of the agent VNFM in order to control or create the VNF pursuant to the request made by the NFVO, and
wherein the agent VNFM is provided in plurality.

7. A method of linking VNFM, comprising:
making a request for control or creation of VNF, the request being made by NFVO;
searching for VNFM managing the VNF; and
linking the NFVO with the VNFM.

8. The method of claim 7, further comprising, after the step of making the request for creation of the VNF, writing information about VNFM managing the VNF based on a location of NFVI in which the VNF is to be installed.

9. The method of claim 7, wherein the VNFM comprises:
main VNFM being linked with the NFVO; and
agent VNFM being linked with the main VNFM and configured for managing the VNF.

10. The method of claim 7, wherein the VNFM comprises:
a plurality of main VNFMs being linked with the NFVO and placed according to each vendor; and
combined agent VNFM being commonly instructed by the plurality of main VNFMs and configured for managing the VNF.

11. The method of claim 9, wherein the main VNFM is configured to manage mapping information of the agent VNFM in order to control or create the VNF pursuant to the request made by the NFVO, and
wherein the agent VNFM is provided in plurality.

12. The method of claim 10, wherein the combined agent VNFM comprises a VNFM search database.
